(19) United States
(12) Patent Application Publication
(10) Pub. No.: US 2026/0243965 A1
(43) Pub. Date: Aug. 20, 2026

(54) ANGLED SUBSTRATE FACET TO MITIGATE SUBSTRATE REFLECTION IN SURFACE COUPLERS

(71) Applicant: Cisco Technology, Inc., San Jose, CA (US)

(72) Inventors: Jean-Luc J. TAMBASCO, Macungie, PA (US); Eng Wen ONG, Breinigsville, PA (US)

(21) Appl. No.: 19/055,615

(22) Filed: Feb. 18, 2025

(51) Int. Cl. G02B 6/34

(52) U.S. Cl. CPC G02B 6/34

(57) ABSTRACT

Apparatuses and methods of fabricating the same are provided. In one aspect, an apparatus includes a substrate, a cladding material disposed on the substrate, a waveguide disposed in the cladding material, and a grating coupler disposed in the cladding material and spaced from the substrate. The grating coupler is arranged to guide an incoming optical signal to the waveguide. The substrate defines a cavity formed, at least in part, by a facet oriented so that a portion of the incoming optical signal that passes through the grating coupler, instead of being guided to the waveguide, reflects off of the facet and is directed away from the grating coupler.

### TECHNICAL FIELD

This disclosure generally relates to photonic chips, and more specifically, to photonic chips having surface couplers.

### BACKGROUND

Silicon photonic chips can include integrated waveguides and surface couplers, such as grating couplers, which can be utilized to surface couple optical fibers with the integrated waveguides. Efficiently receiving light from such optical fibers has presented certain challenges. For instance, while the majority of light of an incoming optical signal from an optical fiber can be received by a grating coupler and guided to a waveguide of a silicon photonic chip, some of the light can pass through the grating coupler. A portion of the light that has passed through the grating coupler can reflect off of the substrate of the silicon photonic chip and can destructively interfere with the incoming light, which can cause significant variability in the performance of the grating coupler.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A is a close-up view of an apparatus according to one or more example aspects of the present disclosure.

FIG. 1B is a close-up view of an apparatus according to one or more example aspects of the present disclosure.

FIG. 1C is a close-up view of an apparatus according to one or more example aspects of the present disclosure.

FIG. 1D is a close-up view of an apparatus according to one or more example aspects of the present disclosure.

FIG. 1E is a close-up perspective view of a substrate defining a cavity according to one or more example aspects of the present disclosure.

FIG. 2 is a close-up view of an apparatus according to one or more example aspects of the present disclosure.

FIG. 3A is a flow diagram for a method of fabricating an apparatus according to one or more example aspects of the present disclosure.

FIG. 3B depicts schematic views of an apparatus being fabricated according to the method of FIG. 3A.

FIG. 4A is a flow diagram for a method of fabricating an apparatus according to one or more example aspects of the present disclosure.

FIG. 4B depicts schematic views of an apparatus being fabricated according to the method of FIG. 4A.

FIG. 5 is a flow diagram for a method according to one or more example aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

In one aspect, an apparatus is provided. The apparatus includes a substrate, a cladding material disposed on the substrate, a waveguide disposed in the cladding material, and a grating coupler disposed in the cladding material and spaced from the substrate. The grating coupler is arranged to guide an incoming optical signal to the waveguide. The substrate defines a cavity formed, at least in part, by a facet oriented so that a portion of the incoming optical signal that passes through the grating coupler, instead of being guided to the waveguide, reflects off of the facet and is directed away from the grating coupler.

In another aspect, a method of fabricating an apparatus is provided. The method includes providing a wafer having a substrate, a cladding material disposed on a planar surface of the substrate, and an optical layer having a grating coupler; forming a trench through the cladding material so as to expose a planar surface of the substrate; and forming, at the planar surface that is exposed, a cavity in the substrate, the cavity having a facet oriented so that a portion of an incoming optical signal that passes through the grating coupler reflects off of the facet and is directed away from the grating coupler.

In a further aspect, a method of fabricating an apparatus is provided. The method includes providing a first wafer having a first substrate and a first cladding material disposed on the first substrate, the first substrate defining a cavity formed, at least in part, by a facet; providing a second wafer having a second substrate, a second cladding material, and an optical layer having a grating coupler; bonding the first cladding material of the first wafer to the second cladding material of the second wafer, wherein in bonding the first wafer to the second wafer, the cavity is arranged relative to the grating coupler such that the facet of the cavity is oriented so that a portion of an incoming optical signal that passes through the grating coupler reflects off of the facet and is directed away from the grating coupler; and removing the second substrate.

In yet a further aspect, a method is provided. The method includes providing an apparatus that includes a substrate, a cladding material disposed on the substrate, a waveguide disposed in the cladding material, and a grating coupler disposed in the cladding material and spaced from the substrate. The substrate defines a cavity formed, at least in part, by a facet. The method also includes transmitting an optical signal to the apparatus such that the grating coupler guides at least a portion of the optical signal to the waveguide and so that the facet reflects a portion of the optical signal that has passed through the grating coupler away from the grating coupler, wherein the facet is angled or curved so as to be non-parallel with a planar surface of the substrate upon which the cladding material is disposed.

In still a further aspect, an apparatus is provided. The apparatus includes a substrate, a cladding material disposed on the substrate, a waveguide disposed in the cladding material, and a grating coupler disposed in the cladding material and spaced from the substrate. The grating coupler is arranged to guide an incoming optical signal to the waveguide. The substrate defines a cavity formed, at least in part, by a facet oriented so that a portion of the incoming optical signal that passes through the grating coupler reflects off of the facet and is directed toward another facet forming, at least in part, the cavity.

### Example Embodiments

Disclosed herein are apparatuses (e.g., photonic chips) that include features for mitigating substrate reflection onto grating couplers. In one aspect, an apparatus can include a substrate, a cladding material disposed on the substrate, a waveguide disposed in the cladding material, and a grating coupler disposed in the cladding material and spaced from the substrate. The grating coupler can be arranged to guide an incoming optical signal to the waveguide. For instance, an optical signal can be transmitted from an optical fiber to the grating coupler in free space. The grating coupler can guide the incoming optical signal to the waveguide, which can carry the optical signal, e.g., to a photodetector. A portion of the incoming optical signal can pass through the grating coupler. That is, some of the light of the incoming optical signal may not be received by the grating coupler and guided to the waveguide. The substrate can define a cavity formed by one or more facets. The cavity can be positioned and at least one of the facets can be oriented so that the portion of the incoming optical signal that has passed through the grating coupler reflects off of the at least one facet and is directed away from the grating coupler, such as toward another facet forming the cavity. This can prevent or reduce light reflected off of the substrate from destructively interfering with incoming optical signals at the grating coupler, which can increase the performance of the grating coupler, among other benefits, advantages, and/or technical effects. Methods of fabricating and utilizing such apparatuses are also provided.

Words of approximation, such as “about” and “substantially”, may each be used herein in the sense of “at, near, or nearly at,” or “within 10% of a stated value,” or “within acceptable manufacturing tolerances,” or any logical combination thereof, for example.

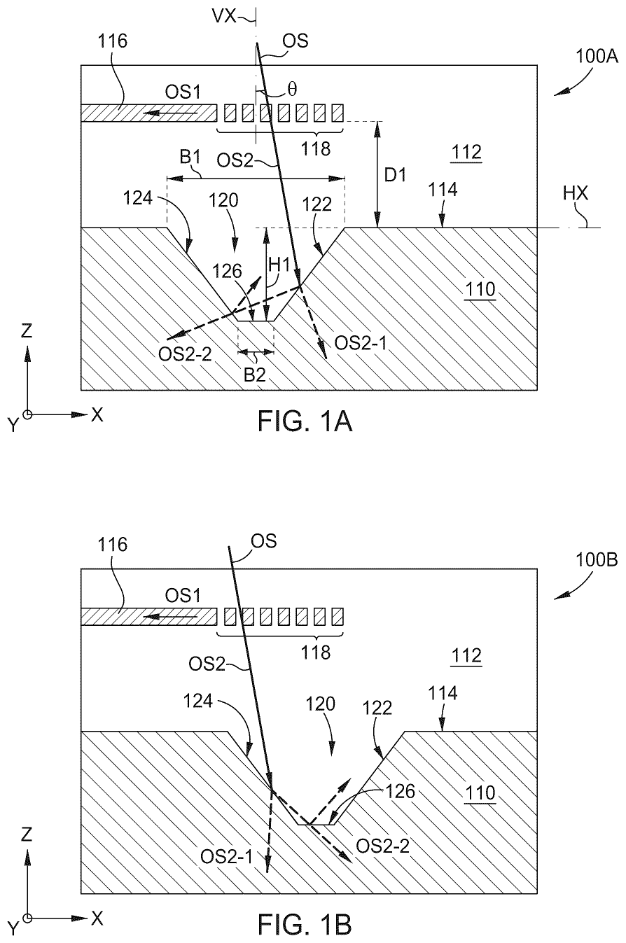

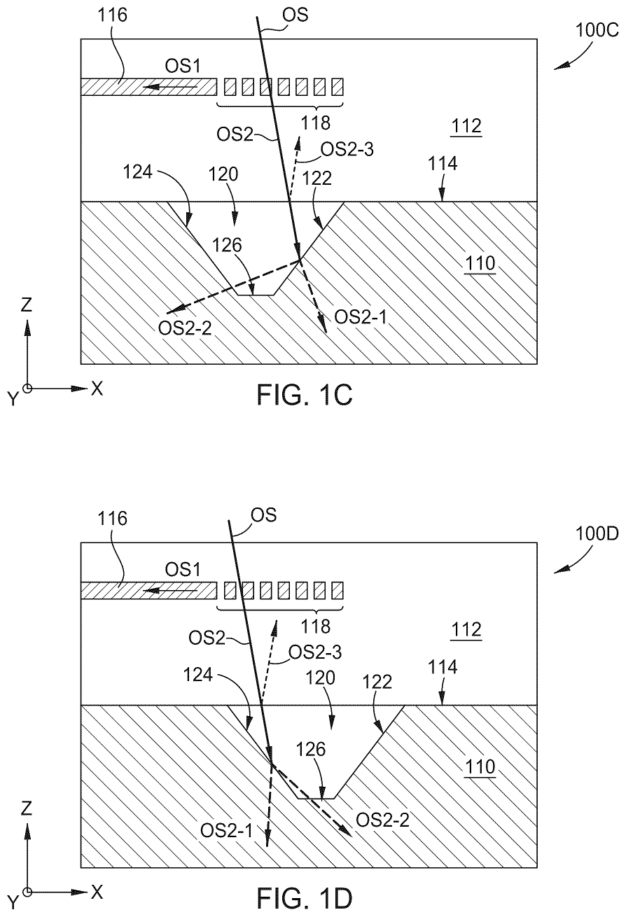

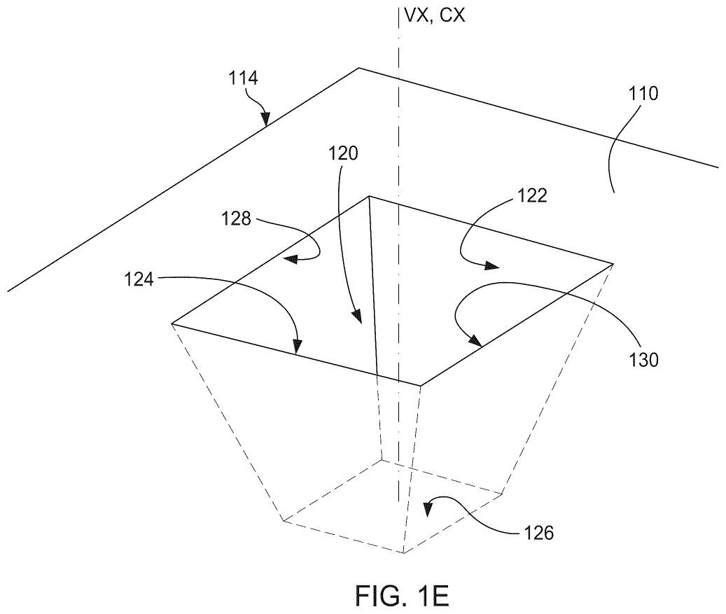

Turning now to the drawings, FIG. 1A is a close-up view of an apparatus 100A according to one or more example aspects of the present disclosure. The apparatus 100A can be a silicon photonic chip utilized in an optical transceiver, for example. For reference, the apparatus 100A defines an X-direction, a Y-direction, and a Z-direction, which are mutually perpendicular to one another. The X-direction can be a transverse direction, the Y-direction can be a lateral direction, and the Z-direction can be a vertical direction, for example.

As depicted in FIG. 1A, the apparatus 100A can include a substrate 110 and a cladding material 112 disposed on the substrate 110. The substrate 110 can include a planar surface 114 upon which the cladding material 112 is disposed. In one or more examples, the substrate 110 can be formed of silicon (Si) and the cladding material 112 can be formed of silicon dioxide (SiO₂). In other examples, the substrate 110 can be formed of another material, such as lithium niobate, quartz, or sapphire. The cladding material 112 can be formed of other oxides besides SiO₂. In at least one example, the cladding material 112 can be formed of multiple layers, which can be formed with the same or different materials. In one or more examples, the cladding material 112 can be formed of multiple oxide layers.

The apparatus 100A can include optical components that collectively form a photonic integrated circuit (PIC). In the depicted example of FIG. 1A, the apparatus 100A includes a waveguide 116 and a grating coupler 118. The waveguide 116 and the grating coupler 118 are optically coupled with one another and are both disposed in the cladding material 112. The grating coupler 118 is spaced from the substrate 110 by a distance D1, e.g., along the Z-direction. In one or more examples, the cladding material 112 can have a refractive index lower than a refractive index of the waveguide 116 and lower than a refractive index of the grating coupler 118. In this regard, the cladding material 112 can have a relatively low refractive index with respect to the refractive indexes of the waveguide 116 and grating coupler 118.

The grating coupler 118 can enable surface coupling. For instance, an optical fiber, such as a single-mode fiber (SMF), can be arranged relative to the grating coupler 118 so that optical signals can travel between the optical fiber and the apparatus 100A, e.g., chip-to-fiber and fiber-to-chip. In one or more examples, the grating coupler 118 can be arranged to receive an incoming optical signal OS oriented at a predetermined angle θ with respect to a vertical axis VX, and can direct at least a portion of the incoming optical signal OS to the waveguide 116, which is represented by a first portion of the incoming optical signal OS1 in FIG. 1A. The waveguide 116 can carry the first portion of the incoming optical signal OS1 through the chip, e.g., to a photodetector. In at least one example, the predetermined angle θ can be about eight degrees (8°).

As further shown in FIG. 1A, at least a portion of the incoming optical signal OS can pass through the grating coupler 118, which is represented by a second portion of the incoming optical signal OS2 in FIG. 1A. The second portion of the incoming optical signal OS2 can travel through the cladding material 112 toward the substrate 110.

The substrate 110 can include features for mitigating substrate reflection. In one or more examples, the substrate 110 can define a cavity 120 arranged, at least in part, underneath the grating coupler 118. As will be explained further below, the cavity 120 can be formed, at least in part, by a facet oriented so that the second portion of the incoming optical signal OS2 that has passed through the grating coupler 118 reflects off of the facet and is directed away from the grating coupler 118. In this way, light that has passed through the grating coupler 118 can be reflected off of the substrate 110 away from the grating coupler 118. This can prevent or reduce the light that destructively interferes with incoming optical signals, which can increase the performance of the grating coupler 118.

In the depicted example of FIG. 1A, the cavity 120 is formed by a first facet 122, a second facet 124, and a base facet 126. The first facet 122 and the second facet 124 are arranged opposite one another and are both planar. The first facet 122 and the second facet 124 are both connected to the base facet 126, which is also planar in this example. The base facet 126 is arranged in a horizontal plane perpendicular to the vertical axis VX. In the example of FIG. 1A, the cladding material 112 extends into and fills the cavity 120.

In one more examples, the cavity 120 can have a trapezoidal cross section that has a height dimension H1, a long base dimension B1, and a short base dimension B2, e.g., as shown in FIG. 1A. The long base B1 dimension can be greater than the short base dimension B2. The height dimension H1, or depth of the cavity 120, can extend between the base facet 126 and the planar surface 114 of the substrate 110 upon which the cladding material 112 is disposed. In at least one example, a ratio of the long base dimension B1 to the height dimension H1 can be between 5:1 and 5:3, including the endpoints of the range. As a first example, the long base dimension B1 can be 50 microns and the height dimension H1 can 10 microns. As a second example, the long base dimension B1 can be 50 microns and the height dimension H1 can 20 microns. As a third example, the long base dimension B1 can be 50 microns and the height dimension H1 can 30 microns.

The first facet 122 can be angled with respect to the vertical axis VX and a horizontal axis HX that is perpendicular to the vertical axis VX. Stated another way, the first facet 122 can be angled so as to be non-parallel with the planar surface 114 upon which the cladding material 112 is disposed. Likewise, the second facet 124 is angled with respect to the vertical axis VX and the horizontal axis HX. Stated differently, the second facet 124 can be angled so as to be non-parallel with the planar surface 114 upon which the cladding material 112 is disposed. In one more examples, the first facet 122 can have a slope that has an opposite sign of a slope of the incoming optical signal OS. For instance, in FIG. 1A, the first facet 122 can be said to have a positive slope while the incoming optical signal OS can be said to have a negative slope. In such examples, the second facet 124 can have a slope that has a same sign of the slope of the incoming optical signal OS. For instance, in FIG. 1A, the second facet 124 can be said to have a negative slope while the incoming optical signal OS can be said to have a negative slope.

Further, in one or more examples, the first facet 122 and the second facet 124 have substantially the same but opposite angles with respect to the vertical axis VX. For instance, in at least one example, the first facet 122 can be angled by positive thirty-five degrees (35°) with respect to the vertical axis VX and the second facet 124 can be angled by negative thirty-five degrees (-35°) with respect to the vertical axis VX. In at least one example, the first facet 122 is angled with respect to the vertical axis VX between positive thirty and forty degrees (30° and 40°) and the second facet VX is angled with respect to the vertical axis VX between negative thirty and forty degrees (−30° and −40°).

As depicted in FIG. 1A, the second portion of the incoming optical signal OS2 that passes through the grating coupler 118 engages the first facet 122, and a refracted portion of the second portion of the incoming optical signal OS2 continues to travel through the substrate 110, as represented by OS2-1. Also, a reflected portion of the second portion of the incoming optical signal OS2 reflects off of the first facet 122 of the substrate 110, as represented by OS2-2. The reflected portion OS2-2 can travel through the cavity 120 and can engage the second facet 124, with a portion of the reflected portion OS2-2 being refracted through the substrate 110 and a portion of the reflected portion OS2-2 being reflected once again off of the substrate 110 (i.e., off of the second facet 124). Accordingly, the first facet 122 is oriented so that the second portion of the incoming optical signal OS2 that passes through the grating coupler 118 reflects off of the first facet 122 and away from the grating coupler 118. This can prevent or reduce light from destructively interfering with incoming optical signals being received by the grating coupler 118, which can increase the performance of the grating coupler 118. The second facet 124 opposite the first facet 122 can further scatter the second portion of the incoming optical signal OS2 away from the grating coupler 118.

In one or more examples, the cavity 120 can be arranged so that the second portion of the incoming optical signal OS2 that passes through the grating coupler 118 initially engages the first facet 122, e.g., as shown in FIG. 1A. In one or more other examples, the cavity 120 can be arranged so that the second portion of the incoming optical signal OS2 that passes through the grating coupler 118 initially engages the second facet 124, e.g., as shown in FIG. 1B.

FIG. 1B shows a close-up view of an apparatus 100B that is configured in a same manner as the apparatus 100A of FIG. 1A except that the cavity 120 is arranged so that the second portion of the incoming optical signal OS2 that passes through the grating coupler 118 initially engages the second facet 124 (rather than the first facet 122 as in FIG. 1A). The apparatus 100B can be a silicon photonic chip, for example. As depicted in FIG. 1B, the second portion of the incoming optical signal OS2 that passes through the grating coupler 118 can initially engage the second facet 124, and the refracted portion of the second portion of the incoming optical signal OS2-1 continues to travel through the substrate 110 while the reflected portion of the second portion of the incoming optical signal OS2-2 reflects off of the second facet 124 of the substrate 110. Thus, in such examples, the second facet 124 can be oriented so that the second portion of the incoming optical signal OS2 that passes through the grating coupler 118 reflects off of the second facet 124 and away from the grating coupler 118, which can prevent or reduce light from destructively interfering with incoming optical signals being received by the grating coupler 118.

In one or more examples, the cladding material 112 can extend into and fill the cavity 120, e.g., as shown in FIGS. 1A and 1B. In one or more other examples, the cavity 120 can be filled with air, e.g., as shown in FIGS. 1C and 1D.

FIG. 1C shows a close-up view of an apparatus 100C that is configured in a same manner as the apparatus 100A of FIG. 1A except that the cavity 120 is air-filled. Thus, in FIG. 1C, the cavity 120 is arranged so that the second portion of the incoming optical signal OS2 that passes through the grating coupler 118 initially engages the first facet 122. The apparatus 100C can be a silicon photonic chip, for example. FIG. 1D shows a close-up view of an apparatus 100D that is configured in a same manner as the apparatus 100B of FIG. 1B except that the cavity 120 is air-filled. Accordingly, in FIG. 1D, the cavity 120 is arranged so that the second portion of the incoming optical signal OS2 that passes through the grating coupler 118 initially engages the second facet 124. The apparatus 100D can be a silicon photonic chip, for example. Minimal reflection can occur when the second portion of the incoming optical signal OS2 engages the air-filled cavity 120, as represented by OS2-3 in FIGS. 1C and 1D.

In one or more examples, a cavity of a substrate can be formed by four (4) angled facets that, along with the base facet, form the cavity to have an inverted truncated pyramid (or inverted pyramidal frustum) shape. For instance, the substrate cavity of any of the apparatuses 100A, 100B, 100C, 100D of FIGS. 1A, 1B, 1C, 1D can be formed to have such a geometry. In one or more other examples, a cavity of a substrate can be formed by more than four (4) angled facets.

FIG. 1E shows a close-up perspective view of a substrate 110 having a cavity 120 formed as an inverted truncated pyramid. As depicted in FIG. 1E, the cavity 120 can be formed by a third facet 128 and a fourth facet 130, in addition to the first facet 122, the second facet 124, and the base facet 126. The third facet 128 and the fourth facet 130 can be arranged opposite one another, much like the first facet 122 and the second facet 124 are arranged opposite one another. The third facet 128 and the fourth facet 130 can have substantially the same but opposite angles with respect to the vertical axis VX. The first, second, third, and fourth facets 122, 124, 128, 130 can be oriented at ninety degrees (90°) from one another with respect to a central axis CX that is coaxial with the vertical axis VX. The first, second, third, and fourth facets 122, 124, 128, 130 can all connect to the base facet 126 at their bottom edges. In such examples, in addition to the first facet 122 and the second facet 124, the third facet 128 and the fourth facet 130 can be used to mitigate back-reflection from the substrate 110 to a grating coupler. The grating coupler and cladding material are not depicted in FIG. 1E for illustrative purposes.

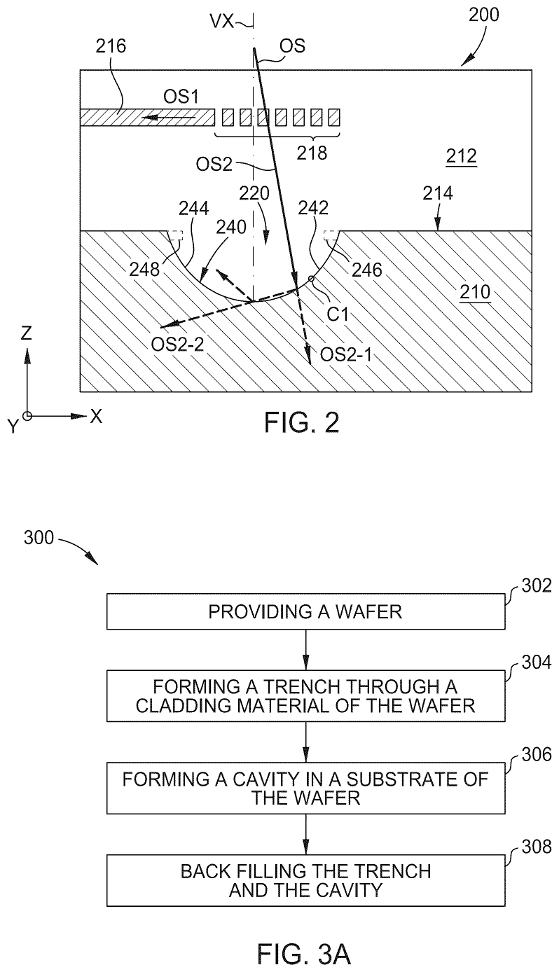

In one or more examples, the facet of the cavity that is oriented to reflect light away from a grating coupler can be curved. FIG. 2 is a close-up view of an apparatus 200. The apparatus 200 can be a silicon photonic chip and can be configured in the same or similar manner as the apparatus 100A of FIG. 1A, except as provided below.

As shown in FIG. 2, the apparatus 200 can include a substrate 210, a cladding material 212 disposed on a planar surface 214 of the substrate 210, a waveguide 216 disposed in the cladding material 212, and a grating coupler 218 also disposed in the cladding material 212 and optically coupled with the waveguide 216. In one or more examples, the cladding material 212 can have a refractive index lower than a refractive index of the waveguide 216 and lower than a refractive index of the grating coupler 218.

In the example of FIG. 2, the substrate 210 can define a cavity 220 arranged, at least in part, underneath the grating coupler 218. Stated another way, the cavity 220 can be positioned such that a facet 240 forming the cavity 220 can be arranged to scatter light transmitted through the grating coupler 218 so that the light is not reflected back to the grating coupler 218. The facet 240 in this example is curved and has concave curvature with respect to the grating coupler 218. The facet 240 can have a first side 242 and a second side 244 delineated by the vertical axis VX, which can be centered on the cavity 220.

When an optical signal OS is transmitted to the apparatus 200, e.g., from an optical fiber or other free-space optical element, the grating coupler 218 can receive a first portion of the incoming optical signal OS1 while a second portion of the incoming optical signal OS2 passes through the grating coupler 218. The second portion of the incoming optical signal OS2 can travel through the cladding material 212 toward the substrate 210. The incoming optical signal OS can be oriented a predetermined angle with respect to the vertical axis VX, such as by eight degrees (8°). The second portion of the incoming optical signal OS2 can engage the first side 242 of the facet 240, and a refracted portion of the second portion of the incoming optical signal OS2-1 continues to travel through the substrate 210, while a reflected portion of the second portion of the incoming optical signal OS2-2 reflects off of the facet 240 away from the grating coupler 218. This can prevent or reduce light from destructively interfering with incoming optical signals being received by the grating coupler 218, which can increase the performance of the grating coupler 218.

In one or more examples, the cavity 220 can be positioned so that a center of the second portion of the incoming optical signal OS2 engages the first side 242 of the facet 240 at or within a predetermined distance from a center C1 of the arc of the first side 242. The predetermined distance can be a distance equal to twenty percent (20%) of the total length of the arc of the first side 242, for example. The total length of the arc of the first side 242 can extend from a center of the arc of the facet 240 to the planar surface 214. In one or more other examples, the cavity 220 can be positioned so that the second portion of the incoming optical signal OS2 initially engages the second side 244 of the facet 240, rather than the first side 242 as in FIG. 2. In such examples, the cavity 220 can be positioned so that a center of the second portion of the incoming optical signal OS2 engages the second side 244 of the facet 240 at or within a predetermined distance from a center of the arc of the second side 244. The predetermined distance can be a distance equal to twenty percent (20%) of the total length of the arc of the second side 244, for example. In one or more other examples, the cavity 220 can be enclosed at least in part by overhangs 246, 248 that hang or extend over the cavity 220. The overhangs 246, 248 can further mitigate back-reflection from the substrate 210 to the grating coupler 218.

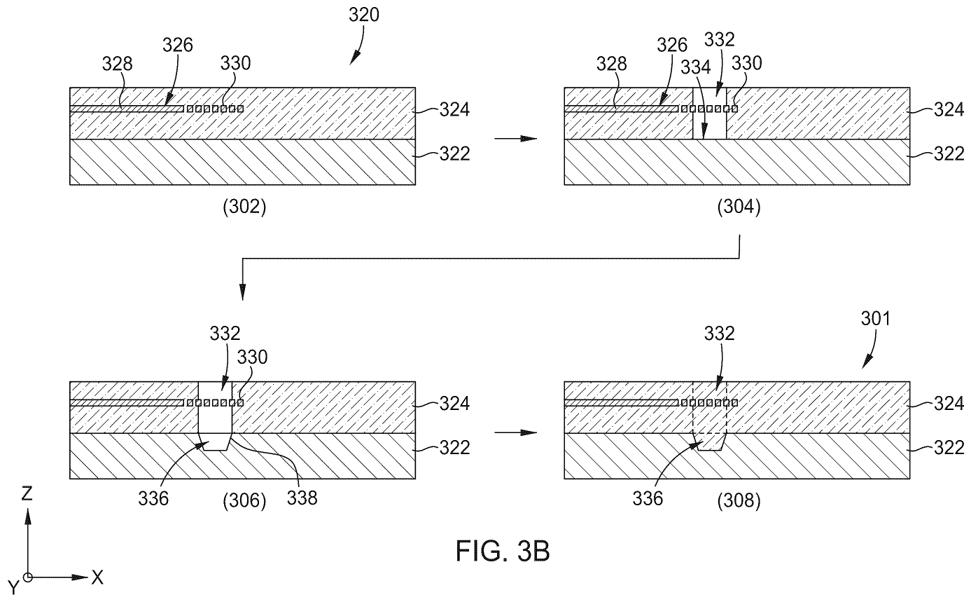

With reference now to FIGS. 3A and 3B, FIG. 3A is a flow diagram for a method 300 of fabricating an apparatus 301 according to one or more aspects of the present disclosure while FIG. 3B depicts schematic views of the apparatus 301 being fabricated according to the method 300. The method 300 can be utilized to form any of the apparatuses disclosed herein.

At 302, the method 300 can include providing a wafer. For instance, as shown FIG. 3B, a wafer 320 having a substrate 322, a cladding material 324, and an optical layer 326 can be provided. In one or more examples, the wafer 320 can be a silicon on insulator (SOI) wafer. In such examples, the substrate 322 can be formed of silicon, the cladding material 324 can be formed of silicon dioxide, and the optical layer 326 can be formed of silicon. The optical layer 326 can include a waveguide 328 and a grating coupler 330 optically coupled thereto. The cladding material 324 can be formed of one or more layers, which can be formed of the same or different materials. In one or more examples, the cladding material 324 can have a refractive index lower than a refractive index of the waveguide 328 and lower than a refractive index of the grating coupler 330.

At 304, the method 300 can include forming a trench through the cladding material. For instance, as shown in FIG. 3B, a trench 332 can be formed through the cladding material 324, e.g., so that a planar surface 334 of the substrate 322 is exposed, or rather, readily accessible for forming a cavity in the substrate 322.

At 306, the method 300 can include forming a cavity in the substrate. For instance, as shown in FIG. 3B, a cavity 336 can be formed in the substrate 322. The cavity 336 can be formed in the substrate 322 so that a facet 338 forming the cavity 336 is arranged to scatter light, which has been transmitted through the grating coupler 330, away from the grating coupler 330. The facet 338 can be an angled planar facet as shown in FIG. 3B, or can be curved, in the example provided in FIG. 2. In one or more examples, forming the cavity 336 in the substrate 322 can include anisotropically etching the cavity 336 into the substrate 322. In at least one example, the cavity 336 can be anisotropically etched into the substrate 322 using potassium hydroxide (KOH). In at least one example, the cavity 336 can be anisotropically etched into the substrate 322 using tetramethylammonium hydroxide (TMAH). In at least one example, the cavity 336 can be anisotropically etched into the substrate 322 using inductively coupled plasma reactive ion etching (ICP-RIE). Example gases that can be used for an ICP-RIE etching process can include O₂, SF₆ and C₄F₈.

At 308, the method 300 can include back filing the trench and the cavity. For instance, as shown in FIG. 3B, the cavity 336 and the trench 332 can be back filled with an oxide material, such as silicon dioxide. In one or more examples, additional materials, such as additional oxide, silicon nitride, metal, etc., can be added to complete the apparatus 301.

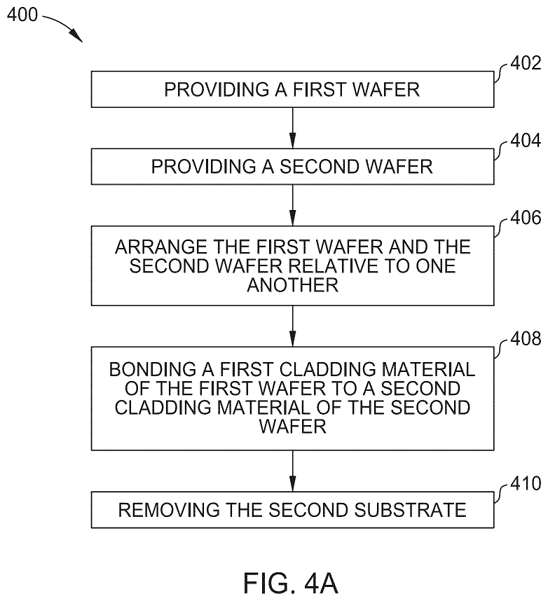

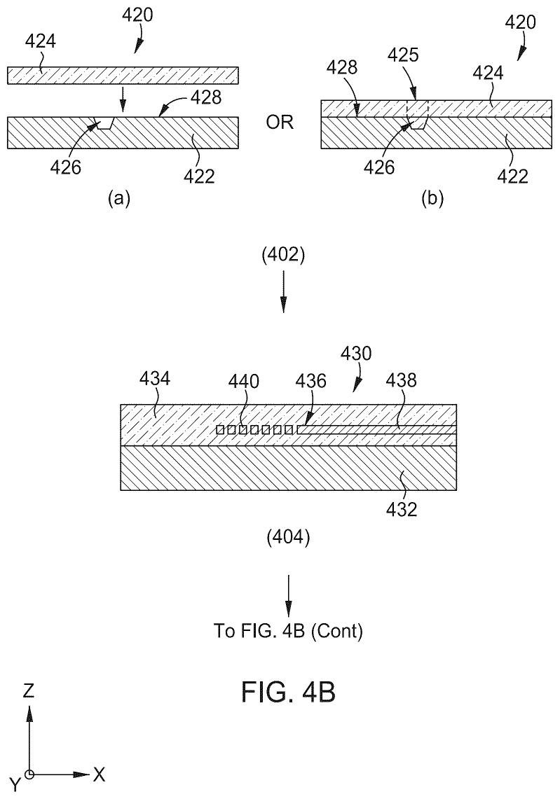

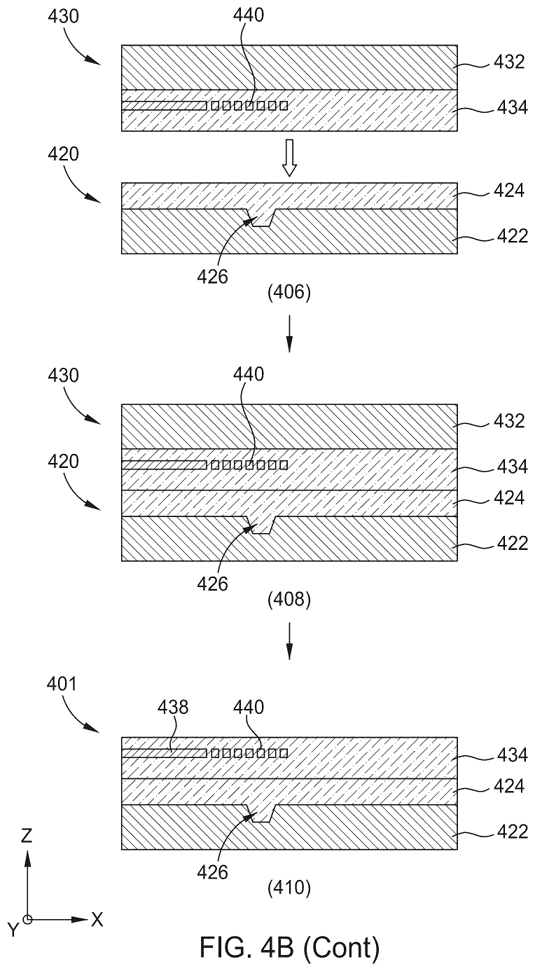

With reference now to FIGS. 4A and 4B, FIG. 4A is a flow diagram for a method 400 of fabricating an apparatus 401 according to one or more aspects of the present disclosure while FIG. 4B depicts schematic views of the apparatus 401 being fabricated according to the method 400. The method 400 can be utilized to form any of the apparatuses disclosed herein.

At 402, the method 400 can include providing a first wafer having a first substrate and a first cladding material disposed thereon, wherein the first substrate defines a cavity. For instance, as shown in FIG. 4B, a first wafer 420 is provided. The first wafer 420 has a first substrate 422 and a first cladding material 424 disposed on the first substrate 422. The first substrate 422 defines a cavity 426. In at least one example, the first substrate 422 can be formed of silicon and the first cladding material 424 can be formed of silicon dioxide. In one or more examples, the first cladding material 424 can be formed of one or more layers, which can be formed of the same or different materials.

In at least one example, as shown in (a) at 402 in FIG. 4B, the cavity 426 can be etched into a planar surface 428 of the first substrate 422 and then the first cladding material 424 can be applied to the first substrate 422, e.g., on the planar surface 428 of the first substrate 422. The cavity 426 can be filled with air or can be filled with oxide. In at least one other example, as shown in (b) at 402 in FIG. 4B, the cavity 426 can be formed by: i) forming a trench 425 in the first cladding material 424 to expose the planar surface 428 of the first substrate 422; ii) etching the cavity 426 into the first substrate 422 where the planar surface 428 is exposed; and iii) backfilling the trench 425 and the cavity 426, e.g., with an oxide material.

In one or more examples, forming the cavity 426 in the first substrate 422 can include anisotropically etching the cavity 426 into the first substrate 422. In at least one example, the cavity 426 can be anisotropically etched into the first substrate 422 using KOH. In at least one example, the cavity 426 can be anisotropically etched into the first substrate 422 using TMAH. In at least one example, the cavity 426 can be anisotropically etched into the first substrate 422 using ICP-RIE. Example gases that can be used for an ICP-RIE etching process can include O₂, SF₆ and C₄F₈.

At 404, the method 400 can include providing a second wafer having a second substrate, a second cladding material, and an optical layer. For instance, as shown in FIG. 4B, a second wafer 430 is provided. The second wafer 430 has a second substrate 432, a second cladding material 434 disposed on the second substrate 432, and an optical layer 436. The optical layer 436 can include a waveguide 438 and a grating coupler 440 optically coupled thereto. The second cladding material 434 can be formed of one or more layers, which can be formed of the same or different materials. In at least one example, the second substrate 432 can be formed of silicon, the second cladding material 434 can be formed of silicon dioxide, and the optical layer 436 can be formed of silicon. In one or more examples, the second cladding material 434 can have a refractive index lower than a refractive index of the waveguide 438 and lower than a refractive index of the grating coupler 440. Also, the first cladding material 424 can have a refractive index lower than the refractive index of the waveguide 438 and lower than the refractive index of the grating coupler 440.

At 406, the method 400 can include arranging the first wafer and the second wafer relative to one another. For instance, as shown in FIG. 4B, the second wafer 430 can be flipped upside down so that the second cladding material 434 of the second wafer 430 faces toward the first cladding material 424 of the first wafer 420. The first wafer 420 and the second wafer 430 can be arranged relative to one another so that, when bonded together, the cavity 426 is positioned so that light that passes through the grating coupler 440 can be reflected off of a facet (e.g., an angled facet) forming the cavity 426 and away from the grating coupler 440.

At 408, the method 400 can include bonding the first cladding material of the first wafer with the second cladding material of the second wafer. Any suitable bonding technique can be utilized, e.g., direct or fusion bonding. In FIG. 4B, the first cladding material 424 of the first wafer 420 is shown bonded with the second cladding material 434 of the second wafer 430. In one or more examples, the first and second wafers 420, 430 can be bonded together with the second substrate 432 still coupled with the second cladding material 434, which can provide mechanical strength to the assembly during bonding, among other benefits. As noted above, the first wafer 420 and the second wafer 430 can be arranged and bonded to one another so that the cavity 426 is positioned such that light that passes through the grating coupler 440 can be reflected off of a facet (e.g., an angled facet) forming the cavity 426 and away from the grating coupler 440, such as toward another facet forming the cavity 426.

At 410, the method 400 can include removing the second substrate. The second substrate 432 can be removed using any suitable technique. In one or more examples, additional materials, such as additional oxide, silicon nitride, metal, etc., can be added to complete the apparatus 401.

While the methods 300 and 400 provide example techniques for fabricating an apparatus, such as any of the apparatuses disclosed herein, it is contemplated that the apparatuses of the present disclosure can be formed by other suitable techniques as well.

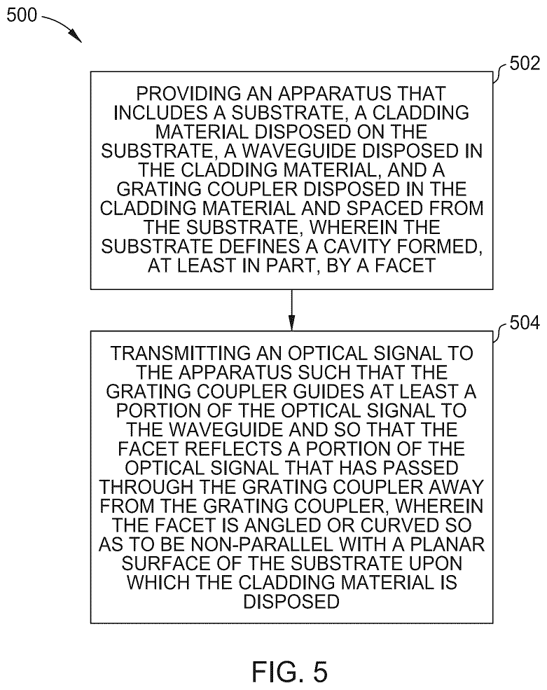

FIG. 5 is a flow diagram for a method 500 according to one or more example aspects of the present disclosure.

At 502, the method 500 can include providing an apparatus that includes a substrate, a cladding material disposed on the substrate, a waveguide disposed in the cladding material, and a grating coupler disposed in the cladding material and spaced from the substrate. The substrate can define a cavity formed, at least in part, by a facet. Any of the apparatuses disclosed herein can be provided at 502.

At 504, the method 500 can include transmitting an optical signal to the apparatus such that the grating coupler guides at least a portion of the optical signal to the waveguide and so that the facet reflects a portion of the optical signal that has passed through the grating coupler away from the grating coupler, wherein the facet is angled or curved so as to be non-parallel with a planar surface of the substrate upon which the cladding material is disposed. For instance, an optical fiber (or other free-space optical element) can be arranged relative to the grating coupler. The grating coupler can guide at least a portion of the optical signal to the waveguide. The grating coupler can be arranged closer to a top surface of the cladding material than to a bottom surface of the cladding material. The bottom surface of the cladding material can interface with the planar surface of the substrate. The facet that forms at least a portion of the cavity can reflect a portion of the optical signal that has passed through the grating coupler away from the grating coupler, e.g., and toward another facet that forms, at least in part, the cavity. The facet can be angled or curved so as to be non-parallel with the planar surface of the substrate upon which the cladding material is disposed.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s).

In view of the foregoing, the scope of the present disclosure is determined by the claims that follow.

We claim:

1. An apparatus, comprising:
a substrate;
a cladding material disposed on the substrate;
a waveguide disposed in the cladding material; and
a grating coupler disposed in the cladding material and spaced from the substrate, the grating coupler being arranged to guide an incoming optical signal to the waveguide,
wherein the substrate defines a cavity formed, at least in part, by a facet oriented so that a portion of the incoming optical signal that passes through the grating coupler, instead of being guided to the waveguide, reflects off of the facet and is directed away from the grating coupler.

2. The apparatus of claim 1, wherein the facet is angled with respect to a vertical axis and a horizontal axis that is perpendicular to the vertical axis.

3. The apparatus of claim 1, wherein the facet is a first facet and the cavity is further formed by a second facet arranged opposite the first facet, and wherein the first facet and the second facet have substantially the same but opposite angles with respect to a vertical axis, and wherein the second facet is oriented so that the portion of the incoming optical signal that passes through the grating coupler reflects off of the second facet away from the grating coupler.

4. The apparatus of claim 3, wherein the first facet is angled with respect to the vertical axis between 30 and 40 degrees and the second facet is angled with respect to the vertical axis between −30 and −40 degrees.

5. The apparatus of claim 3, wherein the cavity is further formed by a third facet and a fourth facet arranged opposite the third facet, and wherein the third facet and the fourth facet have substantially the same but opposite angles with respect to the vertical axis, and wherein the first, second, third, and fourth facets are oriented at ninety degrees from one another with respect to a central axis that is coaxial with the vertical axis.

6. The apparatus of claim 3, wherein the cavity is further formed by a base facet to which the first facet and the second facet are connected, the base facet being arranged in a horizontal plane perpendicular to the vertical axis.

7. The apparatus of claim 1, wherein the facet is planar.

8. The apparatus of claim 1, wherein the facet is curved and has concave curvature with respect to the grating coupler.

9. The apparatus of claim 1, wherein the cladding material extends into and fills the cavity.

10. The apparatus of claim 1, wherein the cavity is filled with air.

11. The apparatus of claim 1, wherein the cavity has a trapezoidal cross section that has a height dimension, a long base dimension, and a short base dimension, with the long base dimension is greater than the short base dimension, and wherein a ratio of the long base dimension to the height dimension is between 5:1 and 5:3, including endpoints.

12. The apparatus of claim 1, wherein the cavity is arranged, at least in part, underneath the grating coupler.

13. The apparatus of claim 1, wherein the facet is angled with respect to a vertical axis and has a slope that has an opposite sign with respect to a slope of the incoming optical signal.

14. The apparatus of claim 1, wherein the facet is angled with respect to a vertical axis and has a slope that has a same sign with respect to a slope of the incoming optical signal.

15. The apparatus of claim 1, wherein the portion of the incoming optical signal that passes through the grating coupler and reflects off of the facet is directed toward, and reflects off of, another facet that forms the cavity.

16. A method of fabricating an apparatus, comprising:
providing a wafer having a substrate, a cladding material disposed on a planar surface of the substrate, and an optical layer having a grating coupler;
forming a trench through the cladding material so as to expose a planar surface of the substrate; and
forming, at the planar surface that is exposed, a cavity in the substrate, the cavity having a facet oriented so that a portion of an incoming optical signal that passes through the grating coupler reflects off of the facet and is directed away from the grating coupler.

17. The method of claim 16, wherein forming the cavity in the substrate comprises anisotropically etching the cavity into the substrate.

18. The method of claim 17, wherein the cavity is anisotropically etched into the substrate using potassium hydroxide (KOH), tetramethylammonium hydroxide (TMAH), or inductively coupled plasma reactive ion etching (ICP-RIE).

19. A method of fabricating an apparatus, comprising:
providing a first wafer having a first substrate and a first cladding material disposed on the first substrate, the first substrate defining a cavity formed, at least in part, by a facet;
providing a second wafer having a second substrate, a second cladding material, and an optical layer having a grating coupler;
bonding the first cladding material of the first wafer to the second cladding material of the second wafer, wherein in bonding the first wafer to the second wafer, the cavity is arranged relative to the grating coupler such that the facet of the cavity is oriented so that a portion of an incoming optical signal that passes through the grating coupler reflects off of the facet and is directed away from the grating coupler; and
removing the second substrate.

20. The method of claim 19, further comprising:
forming the cavity into the first substrate by anisotropically etching.
